(19) United States
(12) Patent Application Publication
(10) Pub. No.: US 2009/0078082 A1
(43) Pub. Date: Mar. 26, 2009

(54) Adapter Ring For Transmission Case To Engine Connection

(75) Inventors: Fredrick R. Poskie, Plymouth, MI (US); Thomas E. Hanley, IV, Canton, MI (US); Elizabeth I. Wooden, Farmington Hills, MI (US); James W. Haynes, Saline, MI (US); Scott H. Wittkopp, Ypsilanti, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/861,698

(22) Filed: Sep. 26, 2007

(51) Int. Cl. F16H 57/02

(52) U.S. Cl. 74/606 R

(57) ABSTRACT

A transmission casing adapter ring is provided that enables a transmission having a common outer casing to be operatively connected to an engine, thus enabling different engines to be used with the common transmission outer casing simply by changing the adapter ring. The adapter ring allows a novel method of assembling a powertrain that permits assembly of the transmission with a generic (i.e., common) type of casing prior to a determination of the engine type or types to be used with the transmission. The adapter ring is aluminum, the transmission case is magnesium, and the engine is cast iron.

### TECHNICAL FIELD

The invention relates to an apparatus for connecting a transmission case to an engine, as well as a method of assembling transmissions.

### BACKGROUND OF THE INVENTION

Vehicle powertrains are complex assemblies including a multitude of components. One of the principal components of a vehicle powertrain is the transmission, which includes a rugged outer housing or case. Transmissions are often designed and built with the intention of being offered for use by various automotive manufacturers across different applications or vehicle models. Economies of scale and simplification of component handling during vehicle assembly dictate the use of at least some common transmission components across these various applications, and even in different types of transmissions, for example in different transmission families with disparate torque and gear ratio specifications. Engines of varying designs are likely used in the different applications, leading to a less than optimal number of different parts and their associated part numbers necessary to achieve the various combinations of transmissions and engines.

### SUMMARY OF THE INVENTION

A transmission case adapter ring is provided that enables an outer transmission housing or case to be connected to an engine, thus enabling use of a common transmission case part number with different engine styles simply by changing the adapter ring. The adapter ring has engine mounting features configured to mount to a predetermined engine mounting face on a specific type or style of engine, and also has a case-side mounting face adapted to mount to a mounting face on the transmission case. The adapter ring is separate from, and mountable to, both the transmission case and the engine. Thus, the adapter ring enables an engine to be connected with any transmission that utilizes the particular type of transmission case.

The adapter rings are relatively small and easy to store, and may be pre-produced and stored until needed. The adapter rings are constructed of light weight, corrosion-resistant material such as aluminum to reduce overall vehicle weight while minimizing corrosion between the transmission case and a cast engine block. With the adapter ring, it is not necessary to produce a customized transmission case for each vehicle model.

Accordingly, in one aspect of the invention, an annular adapter ring has a case-side mounting face at one end adapted to mount to a mounting face of a transmission case. The adapter ring also has an engine-side mounting face at an opposite end that is adapted to mount to a predetermined engine mounting face of a particular type of engine. Preferably the case-side mounting face and the engine-side mounting face of the adapter ring are characterized by bolt patterns identical to bolt patterns of the transmission case and of the engine, respectively.

In another aspect of the invention, because the adapter ring is a separate component from the transmission casing and engine, both may be manufactured separately from the adapter ring, and the adapter ring may be selected from a suitable material independently of the material used for the transmission and engine. For example, the adapter ring may be aluminum, rather than steel, in order to reduce weight and improve fuel economy, while still providing a barrier having sufficient corrosion resistance between potentially incompatible materials, such as a magnesium transmission case and a cast iron engine block.

Within the scope of the invention, a powertrain is provided that includes a transmission having an outer case. The power train also includes an engine having an engine block with an engine mounting face formed on one side, such as with a specific engine bolt pattern. The powertrain includes an annular adapter ring that has a case-side mounting face adapted to mount to the transmission case and an engine-side mounting face adapted to mount to the engine mounting face, to thereby connect the transmission with the engine.

The adapter ring allows a novel method of assembling a powertrain that permits assembly of the transmission with a generic (i.e., common) type of outer case prior to a determination of the engine type or types to be used with the transmission. The method includes maintaining an inventory of transmissions of a first type, each contained within an outer transmission case of a first type. The method includes mounting an adapter ring to the outer case of one of the transmissions. The adapter ring has an engine-side mounting face configured with a predetermined engine bolt pattern adapted for connection with a first type of engine that has the predetermined engine bolt pattern.

Because only the adapter ring has an engine specific feature, i.e. the engine mounting bolt pattern, the method may include mounting a second adapter ring of a second type to the transmission case on a second transmission selected from the inventory, i.e., the second transmission being of identical types as those of the first transmission. The adapter ring of the second type has an engine-side mounting face configured with a second, different, predetermined engine bolt pattern so that the second adapter ring is configured for connection with a second type of engine having the second engine bolt pattern. Thus, the same generic type of transmission case may be used in different applications, such as when different types of engines are to be used with a given type of transmission, simply by utilizing different engine-specific adapter rings.

Furthermore, the entity that maintains the inventory of transmissions may or may not manufacture the adapter rings, and, in either case, may maintain an inventory of the different types of adapter rings and select the appropriate type of adapter ring for mounting to the transmissions, as described above, based on orders received for use of the transmissions with the specified type or types of engines. This permits flexibility in manufacturing output.

Within the scope of the invention, particularly if it is expected that a given type of transmission will be used with two or more different types of engines, the method may include maintaining an inventory of adapter rings of the first and second types, receiving an order for the first type of transmission to be used with the first type of transmission, and, in response to the order, selecting the first type of adapter ring from the inventory for the step of mounting the first adapter ring described above. This allows the transmission to be preassembled, and only the adapter rings need be maintained in a separate, engine specific inventory. Similarly, the method may include receiving an order for the first type of transmission to be used with the second type of engine, and, in response to the order, selecting the second type of adapter ring from the inventory to be used for the step of mounting the second adapter ring described above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration in exploded view of a first powertrain having a transmission with an outer case and first type of engine with an adapter ring to connect the case with the engine;

FIG. 2 is a schematic side view illustration in exploded view of a second powertrain having a transmission with an outer case each of the same type as the corresponding components of FIG. 1, and a second type of engine with another type of adapter ring to connect the transmission case with the second type of engine;

FIG. 3 is a schematic perspective illustration of the adapter ring of FIG. 1;

FIG. 4 is a schematic perspective illustration of the adapter ring of FIG. 2; and

FIG. 5 is a flow chart illustrating a method of assembling a powertrain such as those of FIGS. 1 and 2.

### DESCRIPTION OF THE PREFERRED EMBODIMENTS

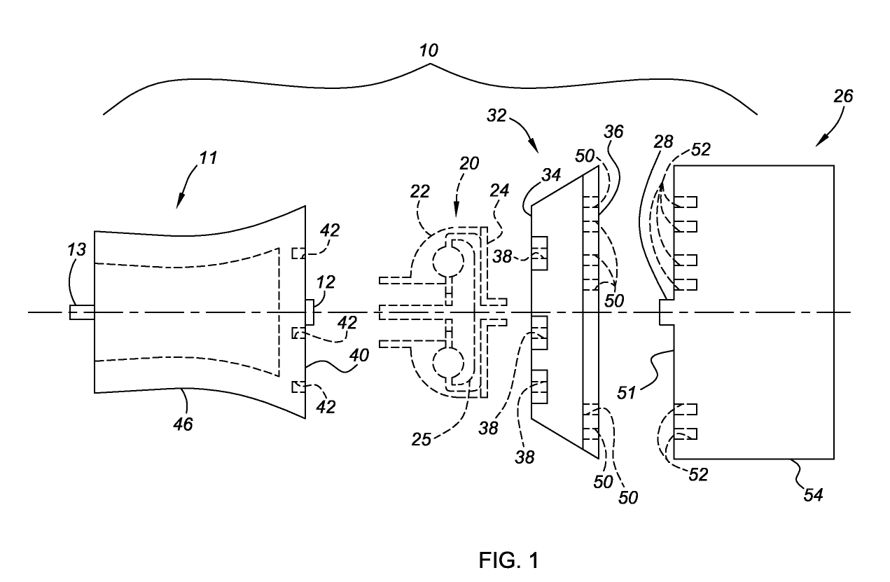

Referring to the drawings, wherein like reference numbers refer to like components, FIG. 1 shows a first powertrain 10 that includes a transmission 111 of a first type, and having an outer housing, shell, or case 46. Case 46 is constructed of a heat resistant and relatively lightweight material, preferably magnesium or a magnesium alloy, but case 46 may also be constructed from other suitable materials within the scope of the invention. Transmission 11 may be configured, for example, as a specific six-speed automatic transmission with numerical speed and torque ratios between a rotatable input member 12 and a rotatable output member 13, as determined by internal gear tooth ratios. Alternatively, transmission 11 may be a hybrid transmission or other type of transmission.

Powertrain 10 includes an engine 26, which may be configured as an internal combustion engine, a fuel cell, or another type of engine sufficient for powering a vehicle (not shown) equipped with transmission 11, in particular by driving input member 12 of transmission 11 via an engine output member 28. Engine 26 is a first type of engine having certain characteristic design parameters, such as displacement volume, number and orientation of cylinders, etc., and/or other design parameters depending on the type or style of engine 26.

It is desirable to be able to utilize transmission 11 with many different engine applications and associated bolt patterns while maintaining as many generic or common components, such as a singular transmission case 46, throughout the various applications. Accordingly, powertrain 10 includes an adapter ring 32 adapted to bolt or otherwise connect transmission case 46 with a specific first type of engine 26. This connection is achieved more specifically between case 46 and an engine block portion 54 of engine 26, preferably a suitable grade of cast iron. Adapter ring 32 is preferably formed or cast from a high-strength, lightweight grade of aluminum to improve corrosion resistance and reduce the weight of transmission 11.

Adapter ring 32 is a first type of adapter ring having a case-side mounting face 34, i.e. an axial surface facing transmission case 46, and an engine-side mounting face 36 at an opposing axial surface. Case-side mounting face 34 includes features suitable for adapting the adapter ring 32 for connection to transmission case 46, such as adapter-to-case bolt openings 38. Case-side mounting face 34 and adapter-to-case bolt openings 38 correspond to mate up with or fit to a transmission case mounting face 40 on an outer surface of transmission case 46, and case bolt openings 42 formed, bored, or otherwise provided in transmission case 46. Adapter-to-case bolt openings 38 and case bolt openings 42 align, and case-side mounting face 34 fits with case mounting face 40 in this manner. Adapter ring 32 is then bolted and doweled (or piloted) to case 46.

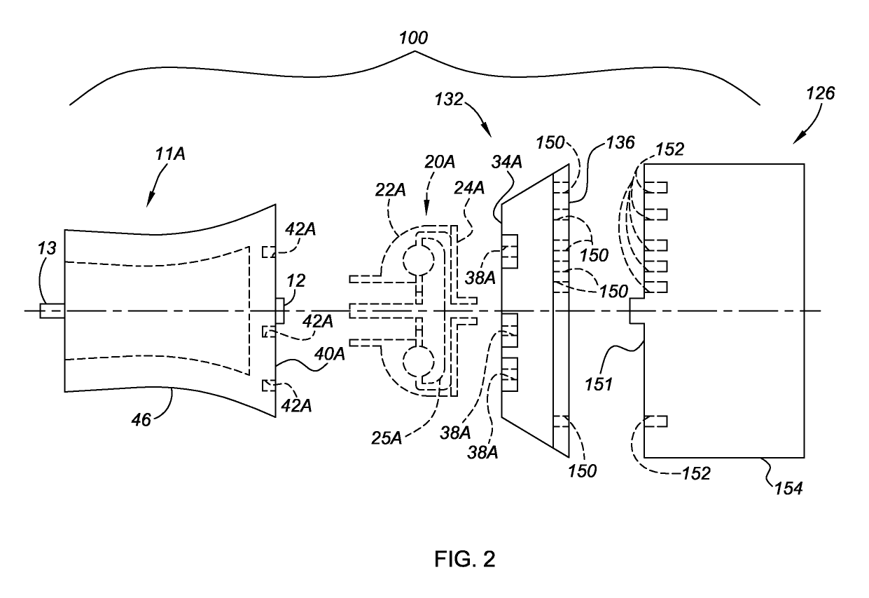

As shown in FIGS. 1 and 2, respectively, an optional torque converter 20, 20A may be provided having a pump portion 22, 22A drivingly connected with a transmission pump (not shown) housed or contained at least partially within transmission case 46. Pump portion 22, 22A is also drivingly connected with a driving component 24, 24A such as a flywheel or damper assembly, which is operatively connectable to the engine output member 28. A turbine portion 25, 25A of torque converter 20, 20A is fluidly driven by discharge of fluid (not shown) from pump portion 22, 22A, and operatively connects to transmission input member 12 to thereby power input member 12, as is known in the art. Therefore, case 46 is preferably configured and/or shaped to allow torque converter 20, 20A to be disposed between transmission 11 and engine 26 if so desired, with adapter ring 32 adapted for use as explained herein without interference with operation of torque converter 20, 20A.

Engine-side mounting face 36 of adapter ring 32 includes adapter-to-engine bolt openings 50 arranged in a predetermined pattern to align with a particular engine mounting face 51 of engine 26. Engine 26 has a predetermined engine bolt pattern, as represented by engine bolt openings 52, that is formed, bored, or otherwise provided in engine block 54 of engine 26.

Because adapter ring 32 is the only component of powertrain 10 having engine-specific features, i.e., features specially adapted to connect to a particular mating feature of engine 26, such as an engine bolt pattern represented by engine bolt openings 52, identical types of the remaining components of powertrain 10 may be used without modification in powertrains having a different type of engine, and only a different type of adapter ring need be used. This is demonstrated by powertrain 100 of FIG. 2, in which a second transmission of the same type as and identical to transmission 11 of FIG. 1, is implemented.

Referring to FIG. 2, an alternate powertrain 100 includes a transmission 11A that may or may not be functionally identical to transmission 11 of FIG. 1, but which is enclosed within an identical case 46 as used with transmission 11 of FIG. 1 as described above. Powertrain 100 includes an engine 126 of a second type which is not identical in configuration to engine 26 of FIG. 1, and specifically having an engine mounting face 151 with a second engine bolt pattern in engine block 154 as represented by engine bolt openings 152. Engine bolt openings 152 differ in number and/or spacing from engine bolt openings 52 of the first type of engine 26 shown in FIG. 1 and described above.

Because a second adapter ring 132 of a second type is used that is different than adapter ring 32 shown in FIG. 1, and that specifically has an engine-side mounting face 136 with mounting features, such as adapter-to-engine bolt openings 150, arranged in a predetermined pattern to align with engine mounting face 151 having the second engine bolt pattern, as represented by engine bolt openings 152. The case-side mounting face 34A of second adapter ring 132 is the same as the case-side mounting face 34 of the first adapter ring 32, as it has identically-spaced mounting features represented by adapter-to-case bolt openings 38A. Adapter-to-case bolt openings 38A are identical to adapter-to-case bolt openings 38 of FIG. 1. Therefore, second adapter ring 132 may be mounted to case mounting face 40A and to case bolt holes 42A of case 46, which are respectively identical to the engine-side mounting face 40 and transmission case bolt openings 42 of transmission case 46 shown in FIG. 1.

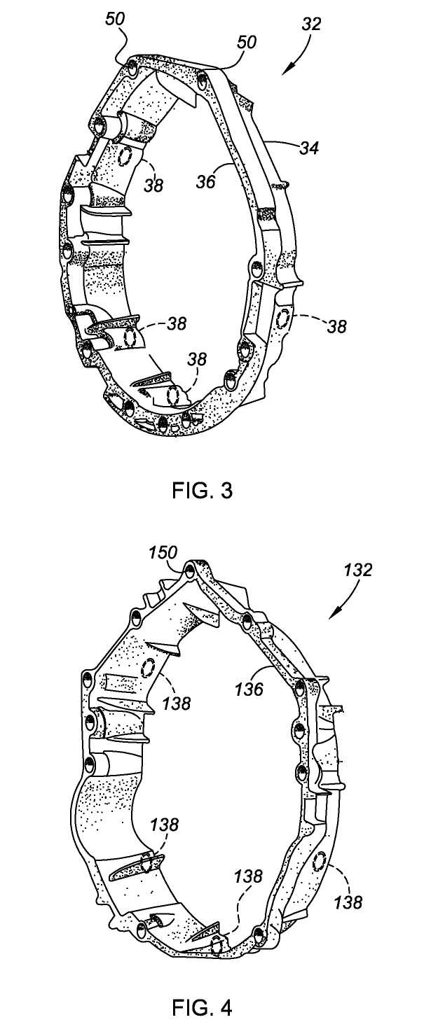

Referring to FIG. 3, adapter ring 32 of FIG. 1 is shown in perspective side view having engine-side mounting face 36 with adapter-to-engine bolt openings 50 spaced from one another to establish a first engine bolt pattern corresponding with the engine bolt pattern of engine 26 of FIG. 1, as represented by engine bolt openings 52 in FIG. 1. Case-side mounting face 34 is at the opposite axial surface of adapter ring 32, with adapter-to-case bolt openings 38 for connection to transmission case 46 of FIG. 1 in the manner described above.

Referring to FIG. 4, adapter ring 132 of FIG. 2 is shown in perspective side view, having engine-side mounting face 136 with adapter-to-engine bolt openings 150 spaced from one another to establish the second engine bolt pattern. This second engine bolt pattern corresponds with an engine bolt pattern of engine 126 of FIG. 2, as represented by engine bolt openings 152. Case-side mounting face 34A is at the opposite axial surface of adapter ring 132, with adapter-to-transmission case openings 138 for connection to case 46 of FIG. 2.

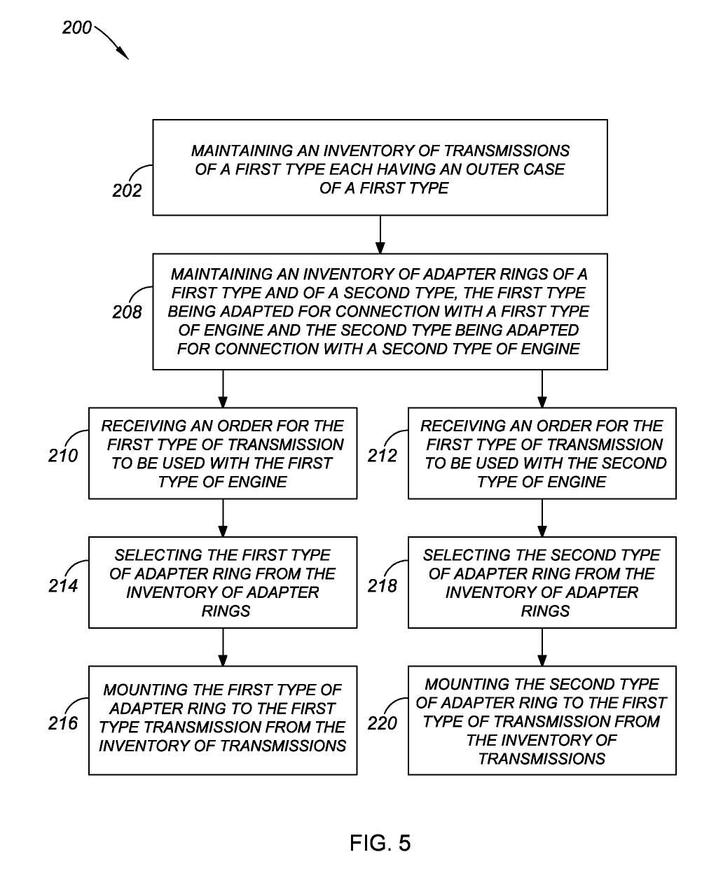

Referring to FIG. 5, a method of assembling powertrains 200 is illustrated in a flow diagram. The steps of the method 200 will be described with reference to powertrains 10, 100 of FIGS. 1 and 2 and the adapter rings 32, 132 of FIGS. 1-4, respectively. Method 200 of FIG. 5 is a preferred embodiment, shows optional steps, and is not intended to be limited to the order of steps shown.

Method 200 includes step 202, maintaining an inventory of transmissions of a first type, such as transmissions 11 of FIGS. 1 and 2, each having an outer housing or case 46 of a first type. Method 200 may also include step 208, maintaining an inventory of adapter rings of a first type (i.e. adapter ring 32 of FIG. 1) and of a second type (i.e. adapter ring 132 of FIG. 2), with the first type being adapted for connection to a first type of engine (i.e. engine 26 of FIG. 1) and the second type being adapted for connection to a second type of engine (i.e. engine 126 of FIG. 2).

Under method 200, the entity assembling transmissions 11 may receive an order under step 210 for the first type of transmission to be used with a first type of engine. Additionally or alternatively, the entity may receive an order under step 212 for the first type of transmission to be used with a second type of engine. In response to step 210, method 200 includes step 214, selecting the first type of adapter ring 32 from the inventory of adapter rings.

After step 214, method 200 includes step 216, mounting the first type of adapter ring 32 to the case 46 of transmission 11 of the first type from the inventory of assembled transmissions. Similarly, in response to step 212, method 200 includes step 218, selecting the second type of adapter ring 132 from the inventory of adapter rings. After step 218, method 200 includes step 220, mounting the second type of adapter ring 132 to the first type of transmission case 46 on a transmission 11 of the first type from the inventory of transmissions.

While the best modes for carrying out the invention have been described in detail, those familiar with the art to which this invention relates will recognize various alternative designs and embodiments for practicing the invention within the scope of the appended claims.

1. An apparatus for connecting a transmission case having a transmission case mounting face with an engine having an engine block portion with a predetermined engine mounting face, comprising:
an annular adapter ring having a transmission case-side mounting face at one end adapted for mounting directly to the transmission case mounting face, and an engine-side mounting face at an opposite end adapted for mounting directly to the predetermined engine mounting face.

2. The annular adapter ring of claim 1, wherein the annular adapter ring is aluminum, the transmission case is magnesium, and the engine block is cast iron.

3. The apparatus of claim 1, wherein the transmission case mounting face includes a predetermined mounting bolt pattern; the predetermined engine mounting face includes a predetermined engine mounting bolt pattern; the adapter ring transmission case-side mounting face is characterized by the transmission case mounting bolt pattern; and the adapter ring engine-side mounting face is characterized by the engine mounting bolt pattern.

4. A powertrain comprising:
a transmission having an outer transmission case;
an engine having an engine block with an engine mounting face formed on one side thereof, and
an annular transmission case adapter ring having a transmission case-side mounting face adapted to mount directly to the transmission case and an engine-side mounting face adapted to mount directly to the engine mounting face, thereby connecting the transmission case with the engine.

5. The powertrain of claim 4, wherein the transmission case mounting face includes a predetermined transmission case bolt pattern; wherein the predetermined engine mounting face includes a predetermined engine bolt pattern; wherein the adapter ring transmission case-side mounting face is characterized by the predetermined transmission case bolt pattern; and wherein the adapter ring engine-side mounting face is characterized by the predetermined engine bolt pattern.

6. The apparatus of claim 5, wherein the annular adapter ring is aluminum, said transmission case is magnesium, and said engine block is cast iron.

7. A method of assembling a powertrain comprising:
maintaining an inventory of transmissions each having an outer transmission case of a first type; and
mounting a first adapter ring to a said outer transmission case of a transmission maintained in said inventory; wherein said first adapter ring is configured with a predetermined first engine mounting bolt pattern on one surface of said first adapter ring, said predetermined first engine bolt pattern being adapted for connection with a first type of engine, and with a predetermined transmission case mounting bolt pattern on another surface of said first adapter ring, said predetermined transmission case mounting bolt pattern being adapted for direct connection with said outer transmission case of said first type.

8. The method of claim 7, further comprising:
mounting a second adapter ring of a second type to another transmission from said inventory; wherein said second adapter ring is configured with a second predetermined engine bolt pattern on one surface of said second adapter ring, said second predetermined engine bolt pattern being adapted for connection with a second type of engine different from said first type of engine, and with said predetermined transmission case mounting bolt pattern on another surface of said second adapter ring for said direct connection.

9. The method of claim 7, further comprising:
prior to said mounting said first adapter ring, receiving an order for the said transmission to be used with the first type of engine;
maintaining an inventory of said first and said second adapter rings; and
in response to said receiving said order for said transmission to be used with said first type of engine, selecting a said first adapter ring from said inventory for said mounting of said first adapter ring to said transmission.

10. The method of claim 9, further comprising:
prior to said mounting of said second adapter ring, receiving an order for said transmission to be used with said second type of engine; and
in response to said receiving said order for said transmission to be used with said second type of engine, selecting a said second adapter ring from said inventory for said mounting of said second adapter ring to said transmission.
